(19) United States
(12) Patent Application Publication
(10) Pub. No.: US 2026/0286118 A1
(43) Pub. Date: Sep. 24, 2026

(54) METHOD FOR PREPARING ULTRA-HIGH MOLECULAR WEIGHT PVDF RESIN BY USING SUPERCRITICAL POLYMERIZATION PROCESS

(71) Applicant: RUYUAN DONGYANGGUANG FLUORINE RESIN CO., LTD., Shaoguan, Guangdong (CN)

(72) Inventors: Bingfa ZHENG, Shaoguan, Guangdong (CN); Huajun YANG, Shaoguan, Guangdong (CN); Tangjian CHENG, Shaoguan, Guangdong (CN); Jingwen DAI, Shaoguan, Guangdong (CN); Qiongfeng CHEN, Shaoguan, Guangdong (CN)

(21) Appl. No.: 19/471,998

(22) PCT Filed: Jun. 15, 2023
(86) PCT No.: PCT/CN2023/100360

§ 371 Date: Oct. 2, 2025

(30) Foreign Application Priority Data
Apr. 3, 2023 (CN) 202310344478.5

(51) Int. Cl. C08L 27/16; C08F 114/22

(52) U.S. Cl. CPC C08L 27/16; C08F 114/22

(57) ABSTRACT

The present application discloses a method for preparing a PVDF resin. The method includes using a supercritical polymerization process, which includes: adding water, a dispersant, a vinylidene fluoride monomer, an initiator and a chain transfer agent into a reactor; performing a polymerization reaction at a pressure of 4.8 MPa to 8.8 MPa and a temperature of 34° C. to 64° C. in the reactor; during a process of the polymerization reaction, continuously supplementing the vinylidene fluoride monomer to maintain the pressure within a range of 4.8 MPa to 8.8 MPa in the reactor, and supplementing the initiator and the chain transfer agent in batches to obtain the PVDF resin after a reaction.

### CROSS-REFERENCE TO RELATED APPLICATION

This application is a National Application of PCT/CN2023/100360 filed on Jun. 15, 2023, which claims priority to Chinese Patent Application No. 202310344478.5 filed on Apr. 3, 2023. The entire content is hereby incorporated by reference.

### FIELD OF TECHNOLOGY

The present application relates to the technical field of polymerization processes, and in particular to a method for preparing an ultra-high molecular weight PVDF resin by using a supercritical polymerization process.

### BACKGROUND

Currently, a commonly used binder in a lithium-ion battery is a polyvinylidene fluoride resin. Polyvinylidene fluoride (PVDF) is widely applied in commercial lithium-ion batteries due to its relatively high dielectric constant, stable electrochemical window and ease of forming a slurry.

PVDF is a semi-crystalline polymer, and its crystallinity is mainly determined by a molecular structure of the resin. The higher the regularity of molecular chains, the higher the crystallinity of the resin, and consequently the higher the strength of the material. Conversely, the more defect structures in the molecular chains, the lower the crystallinity of the resin. An amount of the defect structures in a PVDF molecular mainly depends on a polymerization process condition. Generally, the higher the polymerization temperature, the more defect structures (mainly head-to-head or tail-to-tail structures) are generated, leading to a lower resin crystallinity. These abnormal defect structures have a significant impact on weather resistance, toughness, mechanical strength and impact strength of the polyvinylidene fluoride. Conversely, the lower the reaction temperature, the fewer defect structures are generated, leading to a higher resin crystallinity.

Generally, a temperature of an emulsion polymerization is higher than a temperature of a suspension polymerization, resulting in a lower crystallinity of a resulting resin compared to the suspension polymerization. Also, due to limitations of a emulsion polymerization process, it is usually difficult to prepare an ultra-high molecular weight PVDF resin.

In the prior art, a high molecular weight PVDF is usually prepared by a suspension polymerization process, and a resulting product has a relatively high crystallinity, generally around 50%, which leads to poor flexibility of the resin. When producing an electrode plate, this results in high brittleness of the electrode plate, causing issues such as peeling and fracture during rolling, cutting and winding processes, thereby affecting battery fabrication and performance. Furthermore, a high crystallinity PVDF polymer makes it difficult for electrolyte molecules to flow and wet, increasing a charging/discharging load and leading to higher battery internal resistance.

Patent document CN104710550A discloses a high molecular weight polyvinylidene fluoride resin and a method for preparing the same by using the suspension polymerization process. A polyvinylidene fluoride with a weight-average molecular weight of 300,000 to 1,000,000 was prepared by first performing a reaction at a temperature of 20° C. to 30° C. for 1 to 20 hours, then raising the temperature to a range of 35° C. to 70° C. and performing a polymerization for 5 to 24 hours. During a temperature-raising stage of this method, a significant amount of a VDF monomer remained in a polymerization reactor. Although a crystallinity of a PVDF product was reduced by increasing the temperature, it tended to generate a substantial amount of a low molecular weight PVDF resin. This resulted in poor swellability of the PVDF product in an electrolyte, affecting its application performance in the lithium-ion battery.

Patent document CN110229255A discloses a method for producing a vinylidene fluoride polymer by suspension polymerizing a vinylidene fluoride-containing monomer in water under a supercritical condition, with an aim of achieving a method for producing the vinylidene fluoride polymer in a shorter time and in a simpler manner. In this method, a relevant raw material and an auxiliary were added all at once into the reactor, then a temperature was raised to initiate a reaction. This simplified a reaction procedure. However, a pressure inside the reactor underwent a substantial change from a beginning to an end of the reaction, resulting in a product with a broad molecular weight distribution. Furthermore, during a later stage of the reaction, a significant decrease of the pressure inside the reactor leaded to a slower reaction rate, therefore an overall reaction time remained relatively long.

Patent document CN110183562B discloses a vinylidene fluoride polymer suitable for a lithium battery binder, with a preparation process divided into three stages: first, homopolymerizing a vinylidene fluoride monomer to obtain a homopolymer with an ultra-high molecular weight of 1,600,000 to 2,000,000; second, copolymerizing the vinylidene fluoride and a second monomer to obtain a copolymer with a high molecular weight of 1,000,000 to 1,300,000; and finally, mixing a vinylidene fluoride homopolymer and a copolymer. Although a resulting vinylidene fluoride mixture resin has excellent solution viscosity, bonding performance and flexibility, its production process is cumbersome, a reaction pressure is high, equipment costs are substantial and large-scale production is difficult to achieve.

Currently, in order to improve a quality of a PVDF product and meet an increasingly demanding requirements of the lithium-ion battery, it has become particularly important to develop a process which is capable of producing an ultra-high molecular weight polyvinylidene fluoride with suitable crystallinity.

### SUMMARY

According to a first aspect of the present application, a method for preparing a PVDF resin is disclosed and includes:
using a supercritical polymerization process, which includes: adding water, a dispersant, a vinylidene fluoride monomer, an initiator and a chain transfer agent into a reactor; performing a polymerization reaction at a pressure of 4.8 MPa to 8.8 MPa and a temperature of 34° C. to 64° C. in the reactor; during a process of the polymerization reaction, continuously supplementing the vinylidene fluoride monomer to maintain the pressure within a range of 4.8 MPa to 8.8 MPa in the reactor, and supplementing the initiator and the chain transfer agent in batches to obtain the PVDF resin after a reaction.

According to a second aspect of the present application, a PVDF resin prepared by the above-mentioned method is disclosed.

### DETAILED DESCRIPTION

The present application discloses a method for preparing an ultra-high molecular weight PVDF resin by using a supercritical polymerization process, which includes: adding water, a dispersant, a vinylidene fluoride monomer, an initiator and a chain transfer agent into a reactor; performing a polymerization reaction at a pressure of 4.8 MPa to 8.8 MPa and a temperature of 34° C. to 64° C. in the reactor; during a process of the polymerization reaction, continuously supplementing the vinylidene fluoride monomer to maintain the pressure within a range of 4.8 MPa to 8.8 MPa in the reactor, and supplementing the initiator and the chain transfer agent in batches to obtain the PVDF resin after a reaction.

Specifically, the method includes the following steps:
(1) adding high purity water and the dispersant into the reactor, closing the reactor, evacuating and performing nitrogen gas replacement for several times until an oxygen gas content in the reactor is less than 20 ppm.
(2) heating the reactor, starting stirring, adding the vinylidene fluoride monomer into the reactor to make a pressure in the reactor reaches a range of 4.8 MPa to 8.8 MPa.
(3) adding a certain amount of the initiator and the chain transfer agent into the reactor, performing the polymerization reaction at the pressure of 4.8 MPa to 8.8 MPa and the temperature of 34° C. to 64° C. in the reactor, maintaining constant pressure and temperature in the reactor during the process of the polymerization reaction, adding the vinylidene fluoride monomer continuously to maintain the pressure in the reactor, and supplementing the initiator and the chain transfer agent at intervals.
(4) after the vinylidene fluoride monomer is reacted to a certain amount, stopping the stirring, terminating the reaction, cooling the reactor and relieving the pressure, recovering an unreacted vinylidene fluoride monomer and discharging a product.
(5) washing and drying a suspended material generated through the reaction to obtain a PVDF resin powder.

The high purity water may be deionized water, distilled water or water purified through other methods.

The dispersant is one or a combination of two or more selected from a group consisting of methylcellulose, carboxymethyl cellulose, ethylcellulose, hydroxyethyl cellulose, hydroxypropyl cellulose, hydroxypropylmethylcellulose, polyvinyl alcohol and polyethylene oxide. A usage amount of the dispersant is 0.04 wt % to 0.2 wt % based on a weight of a reaction amount of the vinylidene fluoride monomer.

The initiator is one or a combination of two or more selected from a group consisting of tert-butyl peroxypivalate, diisopropyl peroxydicarbonate, diethyl peroxydicarbonate, dioctyl peroxydicarbonate, di-n-propyl peroxydicarbonate, tert-butyl peroxyneodecanoate and di-2-ethoxyethyl peroxy dicarbonate. A total usage amount of the initiator is 0.05 wt % to 0.15 wt % based on the weight of the reaction amount of the vinylidene fluoride monomer.

The chain transfer agent is a lower ester, a lower ketone or a lower alcohol. In one embodiment, the lower ester is diethyl malonate, ethyl acetate, methyl acetate, diethyl carbonate or dimethyl carbonate, the lower ketone is acetone or methyl ethyl ketone, the lower alcohol is isopropanol or isobutanol. A total usage amount of the chain transfer agent is 0.2 wt % to 0.6 wt % based on the weight of the reaction amount of the vinylidene fluoride monomer.

Specifically, the vinylidene fluoride monomer is added into the reactor through a diaphragm compressor. The initiator and the chain transfer agent are added into the reactor through a metering pump.

Furthermore, in step (3), the polymerization reaction is performed at a pressure of 6.0 MPa to 7.6 MPa and a temperature of 40° C. to 58° C. in the reactor.

Furthermore, before the polymerization reaction in step (3) begins, based on a weight, the metering pump is used to add 50% to 70% of a total usage amount of the initiator and 60% to 80% of a total usage amount of the chain transfer agent into the reactor, and a remaining initiator and chain transfer agent is added in equal portions during the polymerization reaction process. Furthermore, after the polymerization reaction begins, the initiator and the chain transfer agent are supplemented once every 2 to 6 hours, for a total of 1 to 4 times.

Furthermore, in step (4), when a ratio of the reaction amount of the vinylidene fluoride monomer to a weight of the water reaches (25-35):(65-75), the reaction is terminated.

An ultra-high molecular weight PVDF resin prepared through the method of the present application has a weight-average molecular weight of 1,800,000 to 4,000,000, a molecular weight distribution coefficient of 1.6 to 2.6 and a crystallinity of 35% to 45%.

The PVDF resin prepared by the present application is particularly suitable as a binder for a lithium-ion battery, with outstanding advantages such as strong adhesion, low internal resistance, and high cycle capacity retention rate. Correspondingly, a lithium-ion battery made with this PVDF resin has advantages including reduced binder usage, high peel strength, excellent electrical conductivity and high cycle capacity retention rate.

For better understanding and implementation, the technical solution and the technical effect of the present application will be described in detail with the following examples:

### Example 1

13 kg of deionized water and 9 g of carboxymethyl cellulose were added in a 20 L polymerization reactor. The reactor was then closed, evacuated, and nitrogen displacement was performed for several times until an oxygen content inside the reactor was less than 20 ppm. Stirring of the reactor was started, and the reactor was heated to 40° C. Vinylidene fluoride was added into the reactor through the diaphragm compressor until a pressure in the reactor was 7.6 MPa. An aid pump was used to add 5.25 g of tert-butyl peroxypivalate and 18 g of diethyl malonate into the reactor. The reaction was initiated. The diaphragm compressor was used to supplement the vinylidene fluoride to maintain a reaction pressure at 7.6 MPa. 2.25 g of tert-butyl peroxypivalate and 12 g of diethyl malonate were supplemented every 6 hours. This supplementation was carried out once, then the supplementation of the initiator and the chain transfer agent was stopped. When a reaction amount of a supplemented vinylidene fluoride monomer reached 5000 g, the reaction was terminated. A total reaction time was 11.4 hours. An unreacted monomer remaining in the reactor was recovered, and a product was discharged. A resulting suspended material obtained by the polymerization reaction was washed and dried to obtain a white PVDF resin powder.

### Example 2

13 kg of deionized water and 10 g of methylcellulose were added in the 20 L polymerization reactor. The reactor was then closed, evacuated, and nitrogen displacement was performed for several times until the oxygen content inside the reactor was less than 20 ppm. The stirring of the reactor was started, and the reactor was heated to 58° C. The vinylidene fluoride was added into the reactor through the diaphragm compressor until the pressure in the reactor was 5.8 MPa. The aid pump was used to add 3.3 g of diisopropyl peroxydicarbonate and 15.4 g of ethyl acetate into the reactor. The reaction was initiated. The diaphragm compressor was used to supplement the vinylidene fluoride to maintain the reaction pressure at 5.8 MPa. 1.1 g of diisopropyl peroxydicarbonate and 3.3 g of ethyl acetate were supplemented every 4 hours. This supplementation was carried out twice continuously, then the supplementation of the initiator and the chain transfer agent was stopped. When the reaction amount of the supplemented vinylidene fluoride monomer reached 5500 g, the reaction was terminated. The total reaction time was 9.5 hours. The unreacted monomer remaining in the reactor was recovered, and the product was discharged. A resulting suspended material obtained by the polymerization reaction was washed and dried to obtain the white PVDF resin powder.

### Example 3

13 kg of deionized water and 6 g of hydroxypropylmethylcellulose were added in the 20 L polymerization reactor. The reactor was then closed, evacuated, and nitrogen displacement was performed for several times until the oxygen content inside the reactor was less than 20 ppm. The stirring of the reactor was started, and the reactor was heated to 52° C. The vinylidene fluoride was added into the reactor through the diaphragm compressor until the pressure in the reactor reached 6.4 MPa. The aid pump was used to add 2.6 g of di-n-propyl peroxydicarbonate and 10.4 g of isopropanol into the reactor. The reaction was initiated. The diaphragm compressor was used to supplement the vinylidene fluoride to maintain the reaction pressure at 5.8 MPa. 0.87 g of di-n-propyl peroxydicarbonate and 0.87 g of isopropanol were supplemented every 2 hours. This supplementation was carried out three times continuously, then the supplementation of the initiator and the chain transfer agent was stopped. When the reaction amount of the supplemented vinylidene fluoride monomer reached 6500 g, the reaction was terminated. The total reaction time was 7.5 hours. The unreacted monomer remaining in the reactor was recovered, and the product was discharged. The resulting suspended material obtained by the polymerization reaction was washed and dried to obtain the white PVDF resin powder.

### Comparative Example 1

According to a preparation method disclosed by patent document CN104710550A, a PVDF resin was prepared by the following steps:

The polymerization reaction was carried out in a 20 L high pressure reactor, and a water-oil ratio is 2.6/1. 12 kg of pure water, 0.48 kg of HPMC dispersant (a HPMC solution has a mass concentration of 1%, a hydroxypropyl group of 10 mol %, a methoxy group of 25 mol % and a viscosity of 100 mpa·s), 0.12 kg of PVA dispersant (the PVA has a mass concentration of 1%, an alcoholysis degree of 72 mol % and a viscosity of 5.8 mpa·s) were added in a polymerization reactor. The reactor was filled with nitrogen to remove oxygen, then evacuated. Metered 4.0 kg of the vinylidene fluoride monomer was added into the reactor. The stirring at a stirring speed of 400 rpm/min was started. A temperature was raised to about 20° C., 11.2 g of diisopropyl peroxydicarbonate and 52 g of HCFC-123 were added through the metering pump. The polymerization reaction was carried out for 20 hours, then the temperature was raised to about 60° C. and the polymerization reaction was continued for 5 hours. The pressure in the polymerization reactor was reduced to 2 MPa, and the product was discharged after venting. An obtained resin was washed, centrifugally dehydrated and dried.

### Comparative Example 2

According to a preparation method disclosed by patent document CN110229255A, a PVDF resin was prepared by the following steps:

4300 g of vinylidene fluoride (VDF) as a vinylidene fluoride containing monomer, 12.3 kg of ion exchanged water (equal to 2.86 times a supply amount of the vinylidene fluoride containing monomer), 2.2 g of a suspending agent (methylcellulose), 130 g of the chain transfer agent (ethyl acetate) and 8.6 g of a polymerization initiator (di-n-propyl peroxydicarbonate) were added together into a high pressure reactor with an internal volume of 20 L. After heating to an initial polymerization temperature of 40° C. over 1.5 hours, the temperature was maintained at 40° C. for 13.5 hours. A maximum ultimate pressure during this period was 6.0 MPa.

The suspension polymerization was terminated after an elapse of 13.5 hours since an end of heating to 40° C. The pressure at an end of a polymerization was 1.0 MPa. After the polymerization was terminated, a resulting polymer slurry was dehydrated and water washed, and then it was dried at 80° C. for 20 hours to obtain a homopolymer powder of vinylidene fluoride.

### Comparative Example 3

According to a preparation method disclosed by patent document CN110183562B, a PVDF resin was prepared by the following steps:

12 kg of deionized water and 12 g of hydroxypropylmethylcellulose was added in a 20 L high pressure reactor. Nitrogen gas was blown into the reactor to remove oxygen and a pressure test was performed to make an oxygen content in the reactor lower than 10 ppm. 3.5 kg of vinylidene fluoride was added from an initial slot. The stirring was started at a speed of 200 r/min and a temperature was raised to 70° C. 2.52 g of diisopropyl peroxydicarbonate and 22.4 g of diethyl carbonate were added through a metering pump to initiate a reaction. A diaphragm pump was used to supplement the vinylidene fluoride monomer to maintain the reaction pressure at 11.5 MPa. 7.8 g of diethyl carbonate was supplemented every 60 minutes, and 1.32 g of diisopropyl peroxydicarbonate was supplemented every 45 minutes. The reaction was terminated after 2.8 hours. A polymer slurry was devolatilized in a degassing tank, and an unreacted monomer was recovered. The polymer slurry was washed with deionized water until a conductivity of a washing liquid was less than 1 μs/cm. Then, a slurry with a concentration of 35% was spray-dried at 105° C. to obtain a final product.

### Analysis and Test

Samples of PVDF resins prepared in Examples 1-3 and Comparative Examples 1-3 were taken for analysis, and their properties were tested respectively. Results are listed in Table 1 below.

TABLE 1
Comparison of Properties of PVDF Resin Products

| | | | Weight- | |
|---|---|---|---|---|
| | | | average | |
| | Melting | | molecular | Molecular |
| | point/ | | weight | distribution |
| Product | ° C. | Crystallinity | Mw (10⁴) | coefficient |
| Example 1 | 171.5 | 44.8 | 386 | 2.46 |
| Example 2 | 170.2 | 41.3 | 237 | 2.06 |
| Example 3 | 169.4 | 38.8 | 192 | 1.86 |
| Comparative | 172.8 | 44.6 | 70 | 3.05 |
| Example 1 | | | | |
| Comparative | 172.4 | 46.8 | 124 | 2.88 |
| Example 2 | | | | |
| Comparative | 171.8 | 45.2 | 182 | 2.36 |
| Example 3 | | | | |

| | Peeling | Internal | Capacity |
|---|---|---|---|
| | force | resistance | retention rate |
| Product | (N) | (mΩ) | after 300 cycles/% |
| Example 1 | 6.26 | 18 | 97.2 |
| Example 2 | 4.98 | 17 | 97.8 |
| Example 3 | 3.44 | 14 | 98.4 |
| Comparative | 1.85 | 26 | 80.2 |
| Example 1 | | | |
| Comparative | 2.45 | 24 | 84.5 |
| Example 2 | | | |
| Comparative | 3.04 | 20 | 92.1 |
| Example 3 | | | |

In each experiment, the melting point and the crystallinity were determined by a differential scanning calorimeter (DSC) according to ASTM D3418. An employed heating program was as follows: a temperature was raised from 30° C. to 200° C. at a heating rate of 10° C./min, then held at 200° C. for 10 minutes, then lowered to 30° C. at a cooling rate of 20° C./min and held at 30° C. for 10 minutes, and finally the temperature was raised again from 30° C. to 200° C. at a heating rate of 10° C./min. A DSC spectrum during a second melting process was recorded.

A weight-average molecular weight (Mw) and a molecular weight distribution of a polymer were measured by a gel permeation chromatography (GPC). The polymer was completely dissolved in N,N-dimethylacetamide (DMAC), and a N,N-dimethylacetamide solution containing 0.1 mol % lithium bromide was used as an eluent. A specific test condition was as follows: a flow rate was 1 mL/min, a column temperature was 50° C., and a sample concentration was 2 mg/mL.

A peeling strength test requires preparing an electrode using a polymer and an electrode active material, and conducting a measurement according to GB/T2790 1995.

Battery internal resistance value test: an alternating current voltage drop internal resistance measurement method was employed to test an internal resistance value of each lithium battery that was made with the aforementioned electrodes. That is, a small current of 50 mA at a frequency of 1 kHz was applied to each lithium battery, then its voltage was sampled. After a series of processes such as rectification and filtering, an internal resistance value of a corresponding lithium battery was calculated through an operational amplifier circuit.

It can be seen from Table 1 that compared with PVDF resins obtained in Comparative Examples 1-3, PVDF resins prepared in Examples 1-3 have a higher weight-average molecular weight and a narrower molecular weight distribution coefficient, while their crystallinity is relatively lower, exhibiting better adhesive strength to an electrode plate when coating a lithium battery separator.

The experimental result shows that: 1) A PVDF resin prepared by the method of the present application has an extremely high molecular weight, a low molecular weight distribution and a relatively low crystallinity; 2) When this PVDF resin is used to prepare a lithium-ion battery, it can effectively enhance an interaction between an active material and a metal electrode sheet, improving an adhesion performance; 3) The lithium-ion power battery prepared with this PVDF resin has outstanding advantages of low internal resistance and high cycle capacity retention rate.

The above-described embodiments merely represent several embodiments of the present application, and the description thereof is more specific and detailed, but it should not be construed as limiting the scope of the present application. It should be noted that, for those skilled in the art, several variations and improvements may be made without departing from the concept of the present application, and these are all within the protection scope of the present application.

1. A method for preparing a PVDF resin, comprising: using a supercritical polymerization process, which comprises: adding water, a dispersant, a vinylidene fluoride monomer, an initiator and a chain transfer agent into a reactor; performing a polymerization reaction at a pressure of 4.8 MPa to 8.8 MPa and a temperature of 34° C. to 64° C. in the reactor; during a process of the polymerization reaction, continuously supplementing the vinylidene fluoride monomer to maintain the pressure within a range of 4.8 MPa to 8.8 MPa in the reactor, and supplementing the initiator and the chain transfer agent in batches to obtain the PVDF resin after a reaction.

2. The method of claim 1, wherein
before the polymerization reaction begins, adding 50% to 70% of a total usage amount of the initiator and 60% to 80% of a total usage amount of the chain transfer agent into the reactor; during the process of the polymerization reaction, supplementing a remaining amount of the initiator and the chain transfer agent in equal portions.

3. The method of claim 2, wherein
after the polymerization reaction begins, adding the initiator and the chain transfer agent once every 2 to 6 hours, for a total of 1 to 4 times.

4. The method of claim 1, wherein
performing the polymerization reaction at the pressure of 6.0 MPa to 7.6 MPa and the temperature of 40° C. to 58° C. in the reactor.

5. The method of claim 1, wherein
when a ratio of a reaction amount of the vinylidene fluoride monomer to a weight of the water reaches (25-35):(65-75), terminating the reaction.

6. The method of claim 1, wherein
the initiator is an organic peroxide, and a total usage amount of the initiator is 0.05 wt % to 0.15 wt % of the reaction amount of the vinylidene fluoride monomer.

7. The method of claim 1, wherein
the chain transfer agent is a lower ester, a lower ketone or a lower alcohol, and a total usage amount of the chain transfer agent is 0.2 wt % to 0.6 wt % of the reaction amount of the vinylidene fluoride monomer.

8. The method of claim 1, wherein
the dispersant is one or two or more selected from a group consisting of methylcellulose, carboxymethyl cellulose, ethylcellulose, hydroxyethyl cellulose, hydroxypropyl cellulose, hydroxypropylmethylcellulose, polyvinyl alcohol and polyethylene oxide, and a total usage amount of the dispersant is 0.04 wt % to 0.2 wt % of the reaction amount of the vinylidene fluoride monomer.

9. The method of claim 1, wherein
an obtained PVDF resin has a weight-average molecular weight of 1,800,000 to 4,000,000, a molecular weight distribution coefficient of 1.6 to 2.6, and a crystallinity of 35% to 45%.

10. A PVDF resin, wherein the PVDF resin is prepared by the method of claim 1.
